(19) United States
(12) Patent Application Publication
(10) Pub. No.: US 2017/0335945 A1
(43) Pub. Date: Nov. 23, 2017

(54) Hybrid Oil Pump

(71) Applicant: Bayerische Motoren Werke Aktiengesellschaft, Muenchen (DE)

(72) Inventors: Thomas SPIESS, Muenchen (DE); Norbert DEMBINSKI, Muenchen (DE); Attila SOLYMOSI, Muenchen (DE); Walter NEDEREGGER, Muenchen (DE); Matthias BRAIG, Muenchen (DE)

(21) Appl. No.: 15/672,525

(22) Filed: Aug. 9, 2017

Related U.S. Application Data
(63) Continuation of application No. PCT/EP2016/051668, filed on Jan. 27, 2016.

(30) Foreign Application Priority Data
Mar. 16, 2015 (DE) 10 2015 204 734.2

(51) Int. Cl. F16H 57/04; F04B 17/05; F04B 17/03

(52) U.S. Cl. CPC F16H 57/0439; F04B 17/03; F04B 17/05

(57) ABSTRACT

A hybrid oil pump for a motor vehicle includes a pump device, a separate electric motor which is exclusively associated with the hybrid oil pump, and an input shaft. The pump device is electrically drivable by the electric motor or mechanically drivable via the input shaft. An engine lubrication system and a vehicle include such a hybrid oil pump.

### CROSS REFERENCE TO RELATED APPLICATIONS

This application is a continuation of PCT International Application No. PCT/EP2016/051668, filed Jan. 27, 2016, which claims priority under 35 U.S.C. §119 from German Patent Application No. 10 2015 204 734.2, filed Mar. 16, 2015, the entire disclosures of which are herein expressly incorporated by reference.

### BACKGROUND AND SUMMARY OF THE INVENTION

The invention relates to a hybrid oil pump which can be driven both electrically and mechanically.

The oil pumps which are used to lubricate currently conventional internal combustion engines are connected to a crankshaft of the internal combustion engine in a rotationally secure manner, for example, by way of a chain, toothed wheel or belt drive. The drive power which is required to drive the oil pump is branched off from the engine power. With regard to the quantity of oil conveyed, the oil pumps have to be configured for a maximum power operation of the internal combustion engine in order to ensure sufficient lubrication in any operating state. Controlling the quantity of oil conveyed can only be implemented mechanically in a very complex and costly manner. As a result, current oil pumps are coupled to the crankshaft in a rotationally secure manner and convey an unnecessarily high quantity of oil outside maximum power operation.

Thus, there is, on the one hand, potential for energy savings with oil pumps and, on the other hand, it would be desirable to configure the quantity of oil conveyed by the oil pump so as to be adjustable and adaptable to the operating state of the internal combustion engine.

An object of the present invention is to provide a hybrid oil pump whose oil conveying quantity can be adjusted. This and other objects are achieved with a hybrid oil pump according to embodiments of the invention.

According to one embodiment of the invention, a hybrid oil pump for a motor vehicle is provided, having a pump device, a separate electric motor which is associated exclusively with the hybrid oil pump, and an input shaft. The pump device can be driven electrically by the electric motor or mechanically by way of the input shaft. This embodiment affords the advantage that, as a result of the electric drive of the hybrid oil pump, when an internal combustion engine is started, oil is supplied to components of the internal combustion engine which are intended to be lubricated before the internal combustion engine is mechanically started, that is to say, is started by rotating the crankshaft. In comparison, mechanical oil pumps of the prior art are driven only when the internal combustion engine is running, that is to say, during the start-up operation the lubrication is either not optimal or other provisions have to be made.

Another advantage of the electrical operation of the hybrid oil pump is that the drive of the hybrid oil pump is independent of the torque and speed of the internal combustion engine. The operation of the hybrid oil pump and, consequently, the lubrication of the internal combustion engine, can thereby be optimally adapted to the operating state of the internal combustion engine. This leads, for example, to energy savings by excessive lubrication being prevented and optimum lubrication being ensured during load operation. A purely electrically driven oil pump would, however, be critical in the event of a failure since a lack of lubrication very quickly leads to damage to the engine. Therefore, the hybrid oil pump additionally affords the possibility of mechanical driving, which can ensure the lubrication in the event of a failure of the electric drive.

According to another embodiment of the invention, the hybrid oil pump further has an emergency operation device which, in the event of failure of the electric motor, brings about the mechanical driving of the pump device. This embodiment has the advantage that the hybrid oil pump is configured in such a manner that the mechanical drive acts only as a failsafe measure, that is to say, the hybrid oil pump can be primarily electrically driven. This combines the advantages of the electric drive and ensuring the lubrication (that is to say, preventing engine damage).

According to an embodiment of the invention, the emergency operation device comprises a magnetic coupling which opens in the state supplied with current and consequently decouples a mechanical drive of the pump device and closes in the state not supplied with current and consequently couples a mechanical drive of the pump device.

According to an embodiment of the invention, the magnetic coupling can be fitted to a crankshaft of an internal combustion engine or is fitted to the input shaft of the hybrid oil pump.

According to an embodiment of the invention, the emergency operation device has a sensor which determines whether the pump device is driven. This embodiment affords the advantage that it can actually be checked whether the pump device is being electrically driven.

According to an embodiment of the invention, the electric motor is configured for an operating voltage greater than 100 V. This operating voltage has the advantage that the power of the electric motor is sufficiently great to enable reliable lubrication in all operating states of the internal combustion engine.

Furthermore, the invention provides an engine lubrication system having a hybrid oil pump according to one of the embodiments mentioned and a crankshaft.

Furthermore, the invention provides for a vehicle having a hybrid oil pump according to one of the embodiments mentioned.

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 is a schematic illustration of an internal combustion engine with the hybrid oil pump according to an embodiment of the invention.

### DETAILED DESCRIPTION OF THE DRAWING

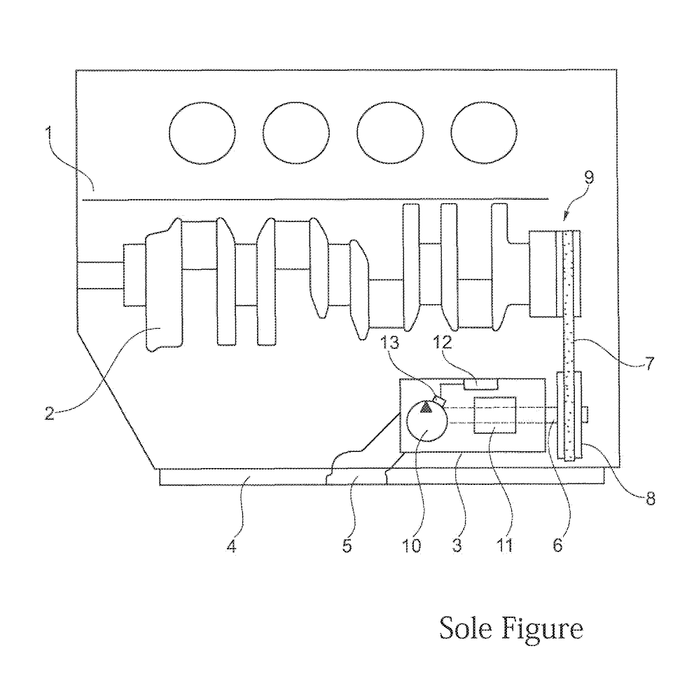

FIG. 1 schematically illustrates an internal combustion engine 1 having a crankshaft 2 and the hybrid oil pump 3. This hybrid oil pump 3 is arranged in a housing of the internal combustion engine 1 or is secured to the housing. At the base side, the internal combustion engine 1 terminates with an oil sump 4 in which the oil accumulates after the components of the internal combustion engine 1, which are intended to be lubricated, have been lubricated. The hybrid oil pump 3 conveys lubrication oil to movable components of the internal combustion engine 1 which are intended to be lubricated, for example, the crankshaft 2, bearing, piston, etc., as known from the prior art. To this end, oil is drawn by a pump device 10 from the oil sump 4 via a suction device 5 and conveyed to the components which are intended to be lubricated by way of corresponding lines. The pump device 10 may be any pump device known from the prior art for conveying liquids, for example, a piston pump, a toothed wheel pump, or a metering pump. The hybrid oil pump 3 has in this instance a separate electric motor 11 which is assigned exclusively to the hybrid oil pump 3 and which drives the pump device 10. The electric motor 11 is configured in such a manner that the lubrication is ensured permanently by sole operation of the electric motor 11 (that is to say, without mechanical support). Preferably, the electric motor 11 for driving the pump device 10 is located in the same housing as the pump device 10 or in a separate housing which is fitted directly to the housing of the pump device 10. In this case, the electric motor 11 is configured in such a manner that it is preferably operated at a voltage level of more than 100 Volts, which enables sufficient conveying power to be provided. Furthermore, the hybrid oil pump 3 has an input shaft 6 via which the hybrid oil pump can be mechanically driven. The input shaft 6 is directly connected to the pump device 10 in a rotationally secure manner. The electric motor 11 is arranged in such a manner that it is also coupled to the pump device 10 via the input shaft 6 or via a separate mechanical connection. During normal operation, in particular fault-free operation, the pump device 10 is driven only by the electric motor 11.

In the event of failure of the electric motor 11 of the hybrid oil pump 3, lubrication can be ensured by way of a mechanical drive. The mechanical drive in which drive power is introduced from outside (that is to say, outside the hybrid oil pump 3) is in this instance only a failsafe measure in the event that the electric motor 11 is defective and no longer provides adequate conveying power. For this functionality, there is provided an emergency operation device which substantially comprises a magnetic coupling 9, a control unit 12 and a sensor 13. Specifically, to this end, the input shaft 6 is coupled to a crankshaft 2 of the internal combustion engine 1. As illustrated in FIG. 1, this can be carried out by way of a belt drive 7, but a toothed wheel drive or a chain drive may also be provided. In the example illustrated in FIG. 1, a belt of the belt drive 7 is placed around a belt pulley 8 which is connected in a rotationally secure manner to the input shaft 6. At the other end, the belt is placed around a magnetic coupling 9 which is in turn coupled to the crankshaft 2 of the internal combustion engine 1.

With regard to the magnetic coupling 9, different embodiments are known from the prior art. A significant aspect in this context is that, in the state not supplied with current, it couples the rotation of the input shaft 6 to the rotation of the crankshaft 2, and in the state supplied with current, it decouples the input shaft 6 from the crankshaft 2. In the example from FIG. 1, the magnetic coupling 9 includes two coupling disks, of which one is connected to the crankshaft 2 in a rotationally secure manner. The belt of the belt drive is placed around the other coupling disk 7 and it is consequently coupled to the input shaft 6 in a rotationally secure manner. If the magnetic coupling 9 is supplied with current, the two coupling disks are decoupled, that is to say, a rotation of the crankshaft-side coupling disk does not lead to a rotation of the belt-drive-side coupling disk. When the magnetic coupling 9 is in the state not supplied with current, the coupling disks are coupled to each other, that is to say, connected to each other in a rotationally secure manner, so that a rotation of the crankshaft-side coupling disk leads to an identical rotation of the drive-belt-side coupling disk. The elements which can be coupled and decoupled do not in this instance necessarily have to be arranged beside each other, but may instead also be arranged coaxially, wherein one element surrounds the other element.

In order to control the magnetic coupling 9, there is provided in the hybrid oil pump 3 a control unit 12 which is electrically connected to the magnetic coupling 9. The control unit 12 and the functionality thereof, which will be described below, can be implemented by way of electrical circuits and/or software. The control unit 12 is connected to a sensor 13, for example, a speed sensor which at least detects whether a conveying operation of the pump device 10 is taking place, and in particular at what speed or with what conveying power. Furthermore, the control unit 12 receives information relating to whether a lubrication operation is intended to take place and optionally also at what conveying power. During normal operation, the control unit 12 always gives priority to the electric motor 11 so that the pump device 10 is driven exclusively by the electric motor 11 during normal operation. This is achieved by the magnetic coupling 9 being supplied with current (and consequently decoupled) if the pump device 10 is operated (by the electric motor 11). If the control unit 12 establishes that an oil conveying operation is intended to be carried out but this does not take place or is insufficient, the control unit 12 switches off the electrical power of the magnetic coupling 9 so that it engages. Subsequently, the pump device 10 is driven mechanically via the belt drive 7. An electric current supply to the electric motor 11 could then be switched off by the control unit 12.

If the control unit 12 determines that an oil conveying operation is intended to be carried out, but this does not take place or is insufficient, different variants are contemplated. In a simple configuration, the control unit 12 can simply determine when an oil conveying operation is required whether the pump device 10 is running or not, and can switch to emergency operation if the pump device 10 is not running. In an improved configuration, the control unit can determine whether the pump device 10 is running at a specific speed (for example, a minimum speed). For example, the control unit 12 can also compare a necessary oil conveying quantity which is dependent on the operating state of the internal combustion engine 1 with an oil conveying quantity supplied by the pump device 10 (determined via the speed of the pump device and detected by the sensor 13) and can determine that normal operation is not present if the supplied oil conveying quantity falls behind the required oil conveying quantity.

It has been described above that the magnetic coupling 9 is fitted to the crankshaft 2. However, the magnetic coupling 9 could equally well be fitted to the input shaft 6.

Furthermore, it has been described above that the hybrid oil pump 3 conveys oil which is used to lubricate the internal combustion engine 1, but the hybrid oil pump 3 is not limited to this application field and can also be used, for example, to lubricate a vehicle gearbox.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hybrid oil pump for a motor vehicle, comprising:
a pump device;
a separate electric motor which is associated exclusively with the hybrid oil pump; and
an input shaft, wherein
the pump device is drivable electrically by the electric motor or mechanically by the input shaft.

2. The hybrid oil pump as claimed in claim 1, further comprising:
an emergency operation device which, in an event of failure of the electric motor, brings about the mechanical drive of the pump device by the input shaft.

3. The hybrid oil pump as claimed in claim 2, wherein the emergency operation device comprises a magnetic coupling which opens in a state supplied with current and consequently decouples the mechanical drive of the pump device and closes in a state not supplied with current and consequently couples the mechanical drive of the pump device.

4. The hybrid oil pump as claimed in claim 3, wherein the magnetic coupling is fitted either to a crankshaft of an internal combustion engine or to the input shaft of the hybrid oil pump.

5. The hybrid oil pump as claimed in claim 2, wherein the emergency operation device has a sensor which determines whether the pump device is driven.

6. The hybrid oil pump as claimed in claim 3, wherein the emergency operation device has a sensor which determines whether the pump device is driven.

7. The hybrid oil pump as claimed in claim 4, wherein the emergency operation device has a sensor which determines whether the pump device is driven.

8. The hybrid oil pump as claimed in claim 1, wherein the electric motor is configured for an operating voltage greater than 100 V.

9. An engine lubrication system, comprising:
a crankshaft; and
a hybrid oil pump comprising a pump device, a separate electric motor associated exclusively with the hybrid oil pump, and an input shaft, wherein the pump device is drivable electrically by the electric motor or mechanically by the input shaft mechanically coupled with the crankshaft.

10. A vehicle, comprising:
a hybrid oil pump comprising a pump device, a separate electric motor associated exclusively with the hybrid oil pump, and an input shaft, wherein the pump device is drivable electrically by the electric motor or mechanically by the input shaft.

11. The vehicle as claimed in claim 10, further comprising a crankshaft of the vehicle, wherein the crankshaft is mechanically coupled with the input shaft to mechanically drive the pump device.
